(19) United States
(12) Patent Application Publication
(10) Pub. No.: US 2013/0144641 A1
(43) Pub. Date: Jun. 6, 2013

(54) Method of Measuring Healthcare Outcomes

(71) Applicant: Russell W. Bessette, Prospect, KY (US)

(72) Inventor: Russell W. Bessette, Prospect, KY (US)

(21) Appl. No.: 13/488,364

(22) Filed: Jun. 4, 2012

Related U.S. Application Data
(60) Provisional application No. 61/493,037, filed on Jun. 3, 2011.

(51) Int. Cl. G06Q 10/06; G06Q 50/22

(52) U.S. Cl. CPC G06Q 10/06395; G06Q 50/22
USPC 705/2

(57) ABSTRACT

Computer-based methods and systems are presented for measuring the quality of healthcare of an individual and for measuring the quality of care of a healthcare provider. The methods comprise the steps of measuring a plurality of factors a first time and a second time, computing a first and second complexity score based on the Z-scores of the first-time and second-time measured values, and determining a quality based on the complexity scores, costs of treatment, and/or elapsed time of treatment.

### CROSS-REFERENCE TO RELATED APPLICATIONS

The present application claims the benefit of the earlier filing date of U.S. Provisional Patent Application No. 61/493,037, filed Jun. 3, 2011, now pending, the disclosures of which is incorporated herein by this reference.

### FIELD OF THE INVENTION

The present invention provides methods of measuring healthcare services, and more particularly, measuring a quality of healthcare services.

### BACKGROUND OF THE INVENTION

Healthcare providers and consumers are both investigating ways to reduce costs in providing healthcare services and treatment, while still maintaining or improving patient outcomes. Some metrics are used to track the performance of healthcare providers, but most quality assurance systems use claims to infer population outcomes. Numerous quality metrics currently exist but nearly all are based on claims data analysis, which relates the number and cost for specific treatment procedures (CPT Codes) to individual diagnostic codes (ICD-9, ICD-10) for patient illness. All of the currently existing quality metrics use quality measures based on tabulation of preventative measures deployed within a population, which fail to provide a patient and provider specific analysis.

Previous metrics employed Healthcare Effectiveness Data and Information Set (“HEDIS”) scores, ordinal stages of disease, single blood markers (e.g., A1c, Hgb), and population claims data. HEDIS scores are a widely used set of performance measures in the managed care industry, developed and maintained by the National Committee for Quality Assurance (“NCQA”). None of these factors are connected to treatment outcome or cost.

Insurance Payers need to know individual provider treatment outcomes for patients grouped by similar illness complexity levels in order to identify preferred provider networks and set risk-adjusted fees.

Hospitals and health providers require outcome measurements based on severity of patient illness in order to defend requests for enhanced reimbursement. Quality measuring groups such as the NCQA, Department of Health (“DOH”) Medicaid, CMS Medicare, require metrics to evaluate treatment outcomes and appropriate cost.

Self-insured companies require value-based outcome results in order to create preferred provider networks for employees. Numerous quality metrics currently exist but nearly all are based on claims data analysis, which relates the number and cost for specific treatment procedures (CPT Codes) to individual diagnostic codes (ICD-9, ICD-10) for patient illness.

### BRIEF SUMMARY OF THE INVENTION

This disclosure presents a method to relate healthcare cost/charges to individual patients and providers based on illness complexity and provider treatment choices, thus providing value-based outcome measurements for risk adjusted payment. The disclosed method provides a way to reach value-based outcomes for medical treatment, which strives to improve medical results per dollar spent on care.

The present method is patient and provider specific, as opposed to current quality measures based on tabulation of preventive measures deployed within a population.

Using computers for analysis, the disclosed Q (Quality) score is based on sequential objective patient tests, such as blood chemistry and physical examination results, which can be organized by organ systems that commonly show dysfunction in specific medical conditions. The final calculation is a single numeric score (complexity score) with broad scalability for illness complexity.

The complexity score increases with disease severity based upon blood tests and physical measurements that deviate from a normal range of values. The complexity score decreases with appropriate treatment and improved health. As such, the complexity score permits quality scoring based on time to achieve health improvement. The complexity score may be used to produce an ROI for treatment results per dollar spent on care.

These outcome scores plotted against the range of costs for various providers treating similar patients, grouped by disease stage or illness complexity, permit quality scoring of healthcare providers within four value-based quadrants. That is, healthcare providers who achieve: (1) Improved health at below average cost; (2) improved health at above average cost; (3) worsening health at above average cost; or (4) worsening health at below average cost.

Employing computers, the method permits analysis of large populations according to treatment results organized by health outcomes based on objective patient measurements recorded in dynamic time. This facilitates earlier detection of poor treatment outcomes and identifies patients and providers for possible quality control intervention.

### DESCRIPTION OF THE DRAWINGS

For a fuller understanding of the nature and objects of the invention, reference should be made to the following detailed description taken in conjunction with the accompanying drawings, in which:

FIG. 1 is a graph showing a severity of an individual's disease at a point in time;

FIG. 2 is a graph showing a severity of another individual's disease at a point in time;

FIG. 3 is graph showing a relation of PCIX score to disease stage;

FIG. 4 is a scatter graph showing Q score on the x-axis and Z-score on the y-axis;

FIG. 5 is a graph of FIG. 4 segmented into four quadrants;

FIG. 6 is a pictorial chart explaining the significance of the four quadrants of the graph in FIG. 5;

FIG. 7 is a bar graph showing a relative cost and health of patient outcomes in FIG. 5;

FIG. 8 is a graph showing the efficiency and ROI of a particular doctor (Dr. B-178) based on the patient data and variable discussed herein;

FIG. 9 is a graph showing the efficiency and ROI of a particular doctor (Dr. N-457) based on the patient data and variable discussed herein;

FIG. 10 is a flowchart of a method according to an embodiment of the present invention; and

FIG. 11 is a flowchart of a method according to another embodiment of the present invention.

### DESCRIPTION OF THE INVENTION

Accountable Care Organizations in Healthcare require patient specific treatment outcomes based on illness severity in order to risk adjust payment and predict likely hospital readmission. The present invention may be embodied as a method for measuring healthcare outcomes. In an embodiment, treatment results are assessed and compared to cost. The method may be referred to as Q (Quality) scoring. The method may be embodied as a tool for relating healthcare costs/charges to individual patients and/or providers based on illness complexity and provider treatment choices. As such, value-based outcome measurements are provided for risk-adjusted payment. The method is patient and provider specific, not an inferred population result, based on objective, physician chosen data and provides dynamic, real-time quality assurance status.

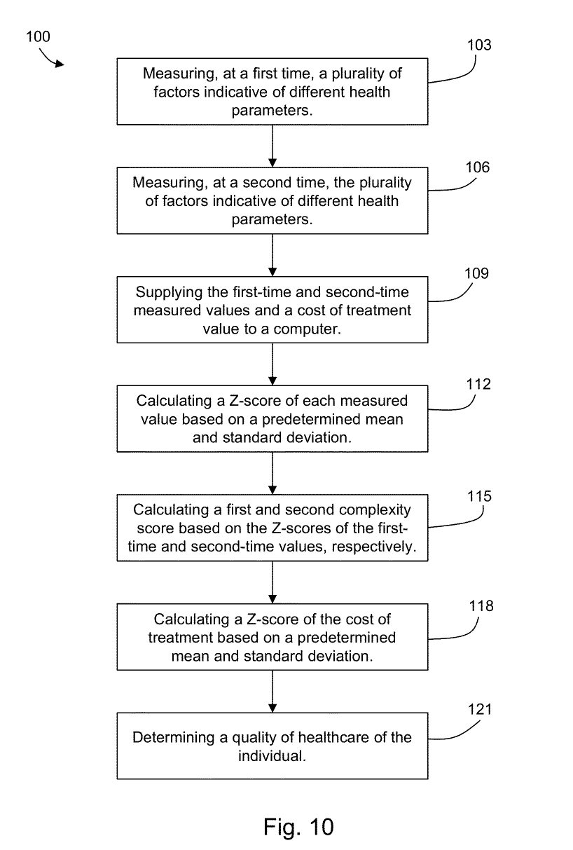

The present invention may be embodied as a method 100 for measuring the quality of healthcare of an individual (see, e.g., FIG. 10). The method 100 comprises measuring 103 the values of one or more factors of the individual at a first time. The factors may be selected to be indicative of different health parameters. The factors can be related to a primary illness and may include factors related to co-factors of the primary illness. The method 100 comprises measuring 106 the values of the one or more factors a second-time.

The first-time and second-time measured values are supplied 109 to a computer. Additionally, the cost of treatment of the individual is supplied 109 to the computer. The cost of treatment could be any cost of treatment, and is preferably the cost of treating the individual during the time between the first measurements and the second measurements.

The computer is caused 112 to standardize the first-time measured values by calculating a Z-score of each of the first-time and second-time measured values. The Z-score is calculated using the mean and standard deviation of a set of data. As a skilled person will recognize, the Z-scores may be calculated by subtracting the mean from the measured value and dividing the result by the standard deviation. The mean may be selected as, for example, the midpoint of the “normal” range for the corresponding factor. The standard deviation may be selected as, for example, one-fourth of the normal range. The Z-score is commonly known in the art to show how many standard deviations a data point is from the mean.

The computer is caused 115 to calculate a first complexity score based on the Z-scores of the first-time measured values. In an embodiment, the computer is caused 115 to calculate the complexity score by summing the Z-scores of the first-time measured values. In other embodiments, the first complexity score is calculated by summing the weighted Z-scores of the measured values. For example, the Z-scores of the measured values may be weighted by a Beta coefficient determined by a linear regression of the measured values with respect to the cost of treatment. In other embodiments, only a sub-set of the Z-scores are summed For example, the complexity score may be determined by summing only those Z-scores that meet a criteria. In an exemplary embodiment, only those Z-scores which are greater than a value are summed The selection of Z-scores may be performed such that only those Z-scores with an absolute value greater than the absolute value of 1.96(Z)(log₂(Z)). In this way, the complexity score may be calculated according to the equation: complexity score=Σₛ_{₁}^{s}^{ₙ}[If Z>|1.96(Zₛ_{₁}, . . . , sₙ)(log₂Zₛ_{₁}, . . . , sₙ)|]. Similarly, the computer is caused 115 to calculate a second complexity score from the Z-scores of the second-time measured values.

The computer is caused 118 to calculate a Z-score of the cost of treatment. The Z-score of the cost of treatment is calculated based on a predetermined mean and standard deviation. The mean and standard deviation may be selected from any appropriate values. For example, the mean and standard deviation may be calculated from the cost of treatment of a population of individuals with a similar illness, a similar healthcare provider, a similar health insurance provider, etc.

The method 100 comprises the step of determining 121 the quality of healthcare (e.g., Q score) based on the first complexity score, the second complexity score, and the Z-score of the cost of treatment. In an embodiment, the quality is determined as a return on investment (“ROI”). ROI may be calculated by subtracting the second complexity score from the first complexity score (change in complexity or A complexity) and dividing by the elapsed time (time of treatment) and the cost. The ROI may be calculated according to the equation:

$$ROI = \frac{( first complexity score - second complexity score ) / elapsed time}{ln ( cost of treatment )} .$$

In another embodiment, the quality of healthcare is calculated by causing the computer to calculate the change in complexity and determining a Q quadrant, as further described below, using Δ complexity and the Z-score of the cost of treatment. The Q quadrant may be determined by, for example, analysis of the sign (positive or negative) of the change in complexity and the Z-score of the cost of treatment, such as:
Quadrant 1: +Δ complexity and −Z_{Cost}
Quadrant 2: +Δ complexity and +Z_{Cost}
Quadrant 3: −Δ complexity and +Z_{Cost}
Quadrant 4: −Δ complexity and −Z_{Cost}

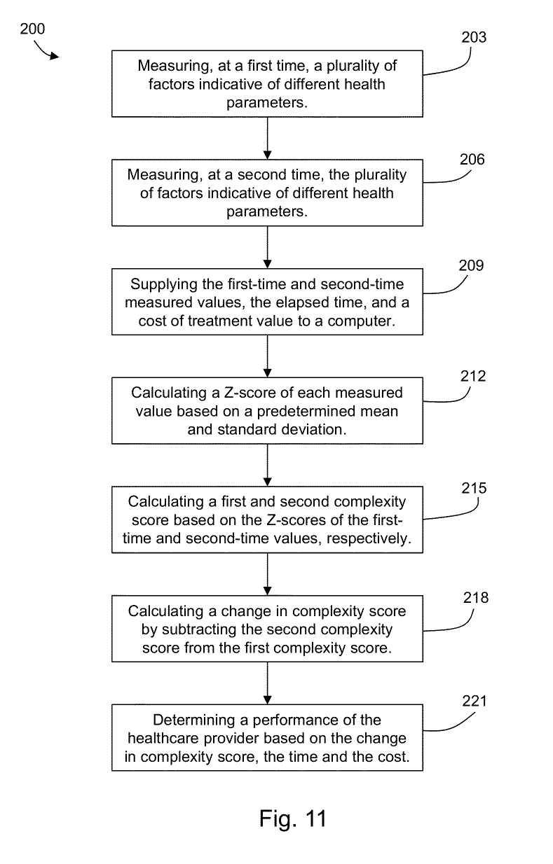

The present invention may be embodied as a method 200 of measuring the performance of a healthcare provider (see, e.g., FIG. 11). The healthcare provider may be measured based on the healthcare outcome of at least one individual treated by the healthcare provider. The method 200 comprises measuring 203 the values of one or more factors of the at least one individual at a first time. The factors may be selected to be indicative of different health parameters. The factors can be related to a primary illness and may include factors related to co-factors of the primary illness. The method 200 comprises measuring 206 the values of the one or more factors a second-time.

The first-time and second-time measured values are supplied 209 to a computer. Additionally, the cost of treatment of the individual is supplied 209 to the computer. The cost of treatment could be any cost of treatment, and is preferably the cost of treating the individual during the time between the first measurements and the second measurements.

The computer is caused 212 to standardize the first-time measured values by calculating a Z-score of each of the first-time and second-time measured values. The Z-score is calculated according to methods known in the art. The Z-score is calculated using the mean and standard deviation of a set of data. As a skilled person will recognize, the Z-scores may be calculated by subtracting the mean from the measured value and dividing the result by the standard deviation. The mean may be selected as, for example, the midpoint of the “normal” range for the corresponding factor. The standard deviation may be selected as, for example, ¼ the normal range. The Z-score is commonly known in the art to show how many standard deviations a data point is from the mean.

The computer is caused 215 to calculate a first complexity score based on the Z-scores of the first-time measured values. In an embodiment, the computer is caused 215 to calculate the complexity score by summing the Z-scores of the first-time measured values. In other embodiments, the first complexity score is calculated by summing the weighted Z-scores of the measured values. For example, the Z-scores of the measured values may be weighted by a Beta coefficient determined by a linear regression of the measured values with respect to the cost of treatment. In other embodiments, only a sub-set of the Z-scores are summed For example, the complexity score may be determined by summing only those Z-scores that meet a criteria. In an exemplary embodiment, only those Z-scores which are greater than a value are summed The selection of Z-scores may be performed such that only those Z-scores with an absolute value greater than the absolute value of 1.96(Z)(log₂(Z)). In this way, the complexity score may be calculated according to the equation: complexity score=Σₛ_{₁}^{s}^{ₙ}[If Z>|1.96(Zₛ_{₁}, . . . , sₙ)(log₂Z_{S}_{₁}, . . . , sₙ)|]. Similarly, the computer is caused 215 to calculate a second complexity score from the Z-scores of the second-time measured values.

The computer is caused 218 to calculate a change in complexity by subtracting the second complexity score from the first complexity score. The method 200 comprises the step of determining 221 the performance of the healthcare provider based on the calculated change in complexity, the time of treatment, and the cost of treatment. In an embodiment, the performance of the healthcare provider may be determined as an efficiency of the provider by dividing the change in complexity by the elapsed time of treatment (e.g., between the first measurements and the second measurements). Another embodiment of the method 200 determines efficiency by dividing the change in complexity by the cost of treatment.

In another embodiment of the method 200, the performance of the healthcare provider is determined by dividing the change in complexity by the elapsed time of treatment (efficiency) and dividing the resulting efficiency by the cost of treatment to determine an ROI for the healthcare provider. The efficiency may be divided by the logarithm (which may be, for example, the natural logarithm) of the cost of treatment. The ROI may be calculated according to the equation:

$$ROI = \frac{( first complexity score - second complexity score ) / elapsed time}{ln ( cost of treatment )} .$$

The method 200 of measuring the performance of a healthcare provider may comprise repeating the calculations for a plurality of individuals. The plurality of individuals may include individuals treated by the healthcare provider (in order to provide additional data for the provider), and the plurality of individuals may include individuals not treated by the healthcare provider (in order to determine the relative performance of the provider).

The present invention may be embodied as a tangible, computer-readable medium containing instructions for causing a computer to implement any of the aforementioned methods.

The present invention may be embodied as a computer-based system for review a plurality of health data records to determined complexity scores, efficiencies, ROIs, Q quadrants, etc. A computer system may be programmed to perform any of the disclosed methods. In this way, a large number of health records may be reviewed to identify problematic treatment of an individual or problematic treatment by a healthcare provider.

The present method is premised on the observation that healthcare costs rise with illness severity. The second premise is that the return on investment (“ROI”) ROI=(better health)/(time to achieve better health)/cost. The present method takes into account that, to efficiently and effectively provide patient healthcare services, accurate measurement of patient outcomes should consider factors that have been overlooked in previous methods.

The present method considers: (1) the score(s) for illness severity; (2) the score(s) for treatment outcome; and (3) the cost(s) related to outcome.

Previous methods are available to measure illness complexity/severity, for example, see U.S. patent application Ser. No. 11/903,846, which is incorporated in its entirety by reference. The present method considers values similar to those produced from the illness severity/complexity measurement method taught in U.S. patent application Ser. No. 11/903,846, in order to measure healthcare outcomes.

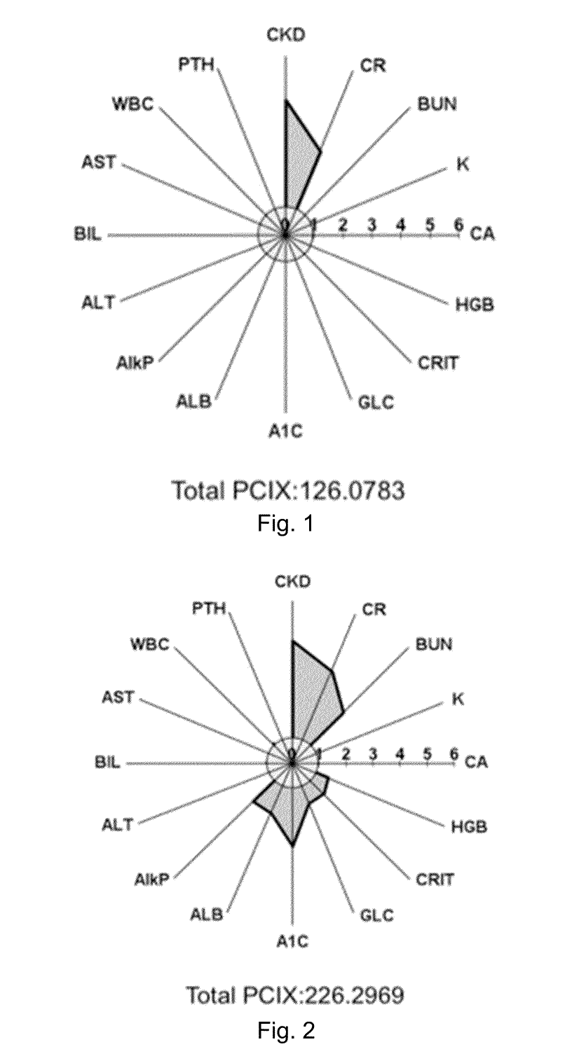

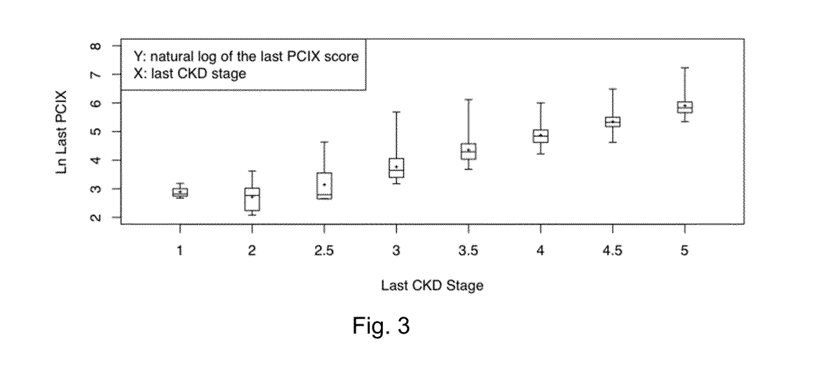

FIGS. 1 and 2 are graphical representations produced using the methods of U.S. patent application Ser. No. 11/903,846, and additionally include a calculated complexity score. These graphs demonstrate that two different patients at the same stage can have different severity levels (complexity scores), and that point is important in assessing healthcare outcomes. FIG. 3 shows that one score can signify the severity level across each stage of the disease.

The Q score method may comprise:

$$1. ROI = \frac{( \frac{Outcome}{Time} )}{Cost} , where \frac{Outcome}{Time} = \frac{Change in P 6}{Time} ;$$

$$and Cost = ln ( \$ paid ) ;$$

$$2. Q Quadrant ( Q Quad ) = plot of ROI ( or change in P 6 ) vs . Z \text{-} score of cost ( {Z}_{Cost} ) .$$

P6 (i.e., complexity score) may be calculated according to the equation:

$$PCIX = {\sum }_{{s}_{1}}^{{s}_{n}} [ If Z > \pm 1.96 ( {Z}_{{s}_{1} , … , {s}_{n}} ) ( {log}_{2} {Z}_{{s}_{1} , … , {s}_{n}} ) ]$$

Where Zₛ_{ₙ} is the absolute value of the n^{th} sample's Z-score.

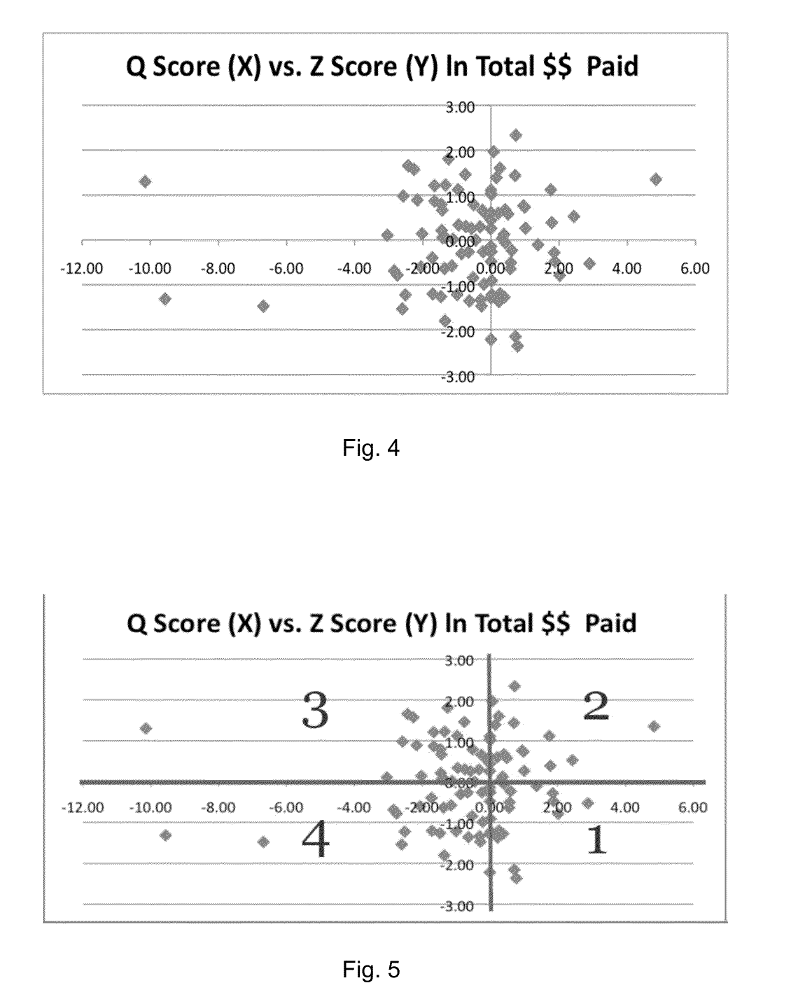

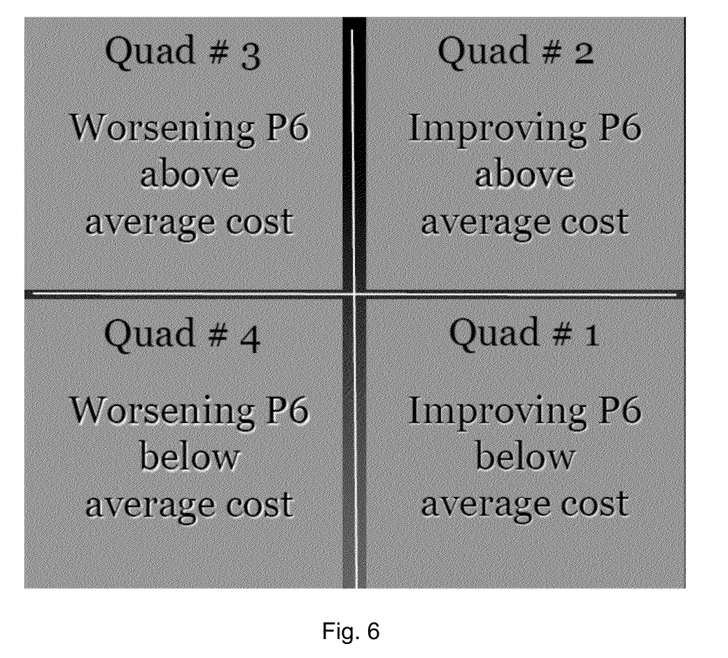

A Q Quad may be determined by a scatter plot of Q ROI vs. Z_{cost} so as to identify a quality quadrant. The Q Quad can be graphically demonstrated by plotting in a scatter plot of Q ROI vs. Z-score cost resulting in a graph, for example, like that shown in FIG. 4. That scatter plot graph can then be segmented into quadrants that demonstrate the value of the total money paid for the treatment and result as shown in FIGS. 5 and 6.

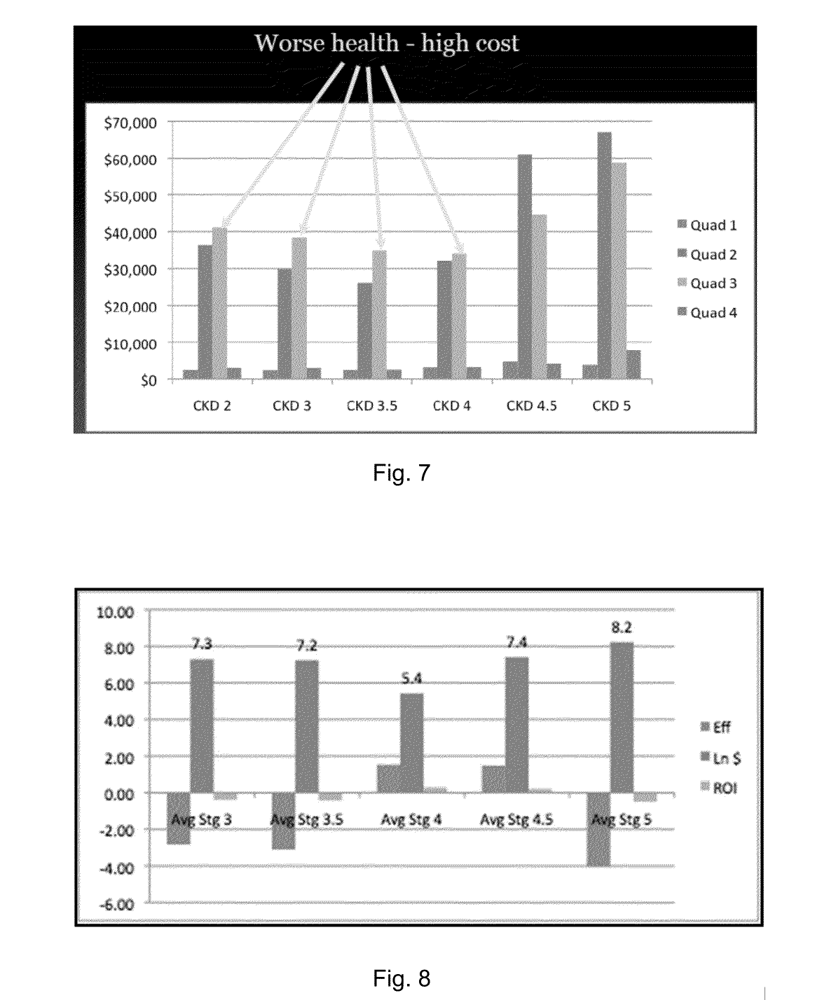

FIG. 7 is a bar graph showing the cost of treatment (y-axis) for each quadrant at various disease stages (x-axis). It can be seen that quadrant 3 provides the worst healthcare outcomes (i.e., worst patient health matched with high cost), while quadrant 1 (bar one) provides improving health with below average cost.

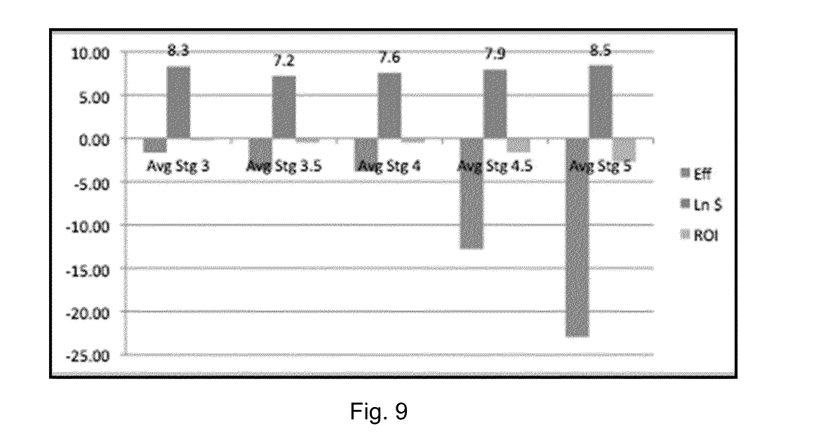

The Q value (quadrant) can define which patients receive a: good result at below average market cost (quadrant 1); good result at above average market cost (quadrant 2); poor result at above average market cost (quadrant 3); or poor result at below average market cost (quadrant 4). The Q score also provides individual provider scores based on: the treatment measure by improvement in health/time; and that is plotted against the cost to achieve those results among providers who treated similar levels of patient illnesses. FIG. 8 is a graph that shows the relative efficiency of a particular doctor (Dr. B-178), where efficiency (labeled “Eff”—left bar of each group of three bars) is P6/(time of treatment) and ROI (right bar) is efficiency/ln ($ paid). FIG. 9 is a similar graph showing the values for another doctor (Dr. N-457).

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

We claim:

1. A method of measuring quality of healthcare of an individual, the method comprising the steps of:
measuring the values of a plurality of factors indicative of different health parameters of the individual at a first time;
measuring the values of the plurality of factors of the individual at a second time;
supplying the first-time and second-time measured values and a cost of treatment value for the individual to a computer;
causing the computer to calculate a Z-score of each of the first-time and second-time measured values based on a predetermined mean and standard deviation of each factor;
causing the computer to calculate a first complexity score based on the Z-scores of the first-time measured values and a second complexity score based on the Z-scores of the second-time measured values;
causing the computer to calculate a Z-score of the cost of treatment based on a predetermined mean and standard deviation of treatment costs; and
determining a quality of healthcare of the individual based on the first and second complexity scores and the Z-score of the cost of treatment.

2. The method of claim 1, wherein the first complexity score is calculated by summing the Z-scores of first-time measured values and the second complexity score is calculated by summing the Z-scores of the second-time measured values.

3. The method of claim 1, wherein the first complexity score is calculated by summing the weighted Z-scores of first-time measured values and the second complexity score is calculated by summing the weighted Z-scores of the second-time measured values.

4. The method of claim 3, wherein each Z-score is weighted by a coefficient determined by linear regression of the plurality of factors with respect to the cost of treatment.

5. The method of claim 1, wherein each complexity score is calculated according to the equation: complexity score=Σₛ_{₁}^{s}^{ₙ}[If Z>|1.96(Zₛ_{₁}, . . . , sₙ)(log₂Z_{S}_{₁}, . . . , sₙ)|], where sₙ is a measured value of a factor, n is the number of factors, and Zₛ_{ₙ} . is the absolute value of the Z-score of sₙ.

6. The method of claim 1, further comprising the step of causing the computer to calculate a return on investment (ROI) of the healthcare of the individual.

7. The method of claim 6, wherein the ROI is calculated according to the equation:
$$ROI = \frac{( first complexity score - second complexity score ) / elapsed time}{ln ( cost of treatment )} .$$

8. The method of claim 1, wherein step of determining the quality of healthcare of the individual further comprises the sub-steps of:
causing the computer to subtract the second complexity score from the first complexity score to calculate a change in complexity score;
causing the computer to determine a quality of healthcare as a quadrant based on the change in complexity score and the Z-score of the cost of treatment.

9. A method of measuring performance of a healthcare provider based on the healthcare outcome of at least one individual treated by the healthcare provider, comprising the steps of:
measuring the values of a plurality of factors indicative of different health parameters of the at least one individual at a first time;
measuring the values of the plurality of factors of the at least one individual at a second time;
supplying the first-time and second-time measured values, a cost of treatment value, and an elapsed time value to a computer;
causing the computer to calculate a Z-score of each of the first-time and second-time measured values based on a predetermined mean and standard deviation of each factor;
causing the computer to calculate a first complexity score based on the Z-scores of the first-time measured values and a second complexity score based on the Z-scores of the second-time measured values;
causing the computer to subtract the second complexity score from the first complexity score to calculate a change in complexity score; and
causing the computer to determine a performance of the healthcare provider based on the change in complexity score, the elapsed time, and the cost of treatment.

10. The method of claim 9, wherein the step of causing the computer to determine a performance of the healthcare provider further comprises the sub-step of:
causing the computer to divide the change in complexity score by the elapsed time to calculate an efficiency of the healthcare provider.

11. The method of claim 10, wherein the step of causing the computer to determine a performance of the healthcare provider further comprises the sub-step of:
causing the computer to divide the efficiency by the logarithm of the cost of treatment to calculate a ROI of the healthcare provider.

12. The method of claim 9, wherein the steps of the method are repeated for a plurality of individuals.

13. The method of claim 9, wherein the first complexity score is calculated by summing the Z-scores of first-time measured values and the second complexity score is calculated by summing the Z-scores of the second-time measured values.

14. The method of claim 9, wherein the first complexity score is calculated by summing the weighted Z-scores of first-time measured values and the second complexity score is calculated by summing the weighted Z-scores of the second-time measured values.

15. The method of claim 14, wherein each Z-score is weighted by a coefficient determined by linear regression of the plurality of factors with respect to the cost of treatment.

16. The method of claim 9, wherein each complexity score is calculated according to the equation: complexity score=Σₛ_{₁}^{s}^{ₙ}[If Z>|1.96(Zₛ_{₁}, . . . , sₙ)(log₂Z_{S}_{₁}, . . . , sₙ)|], where sₙ is a measured value of a factor, n is the number of factors, and Zₛ_{ₙ}. is the absolute value of the Z-score of sₙ.
